(19) United States
(12) Patent Application Publication
(10) Pub. No.: US 2006/0145533 A1
(43) Pub. Date: Jul. 6, 2006

(54) Method and device for controlling at least one wheel-brake unit of a vehicle

(76) Inventors: Karsten Braeuer, Hollenstedt (DE); Michael Schopper, Stuttgart (DE); Davide Tondelli, Esslingen (DE)

Correspondence Address: FASSE PATENT ATTORNEYS, P.A., P.O. BOX 726, HAMPDEN, ME, 04444-0726, US

(21) Appl. No.: 10/534,328

(22) PCT Filed: Oct. 15, 2003
(86) PCT No.: PCT/EP03/11402

§ 371 Date: Oct. 18, 2005

(30) Foreign Application Priority Data
Nov. 9, 2002 (DE) 102 52 147.6
Feb. 15, 2003 (DE) 103 06 362.5

(51) Int. Cl. B60T 8/32

(52) U.S. Cl. 303/191

(57) ABSTRACT

The invention relates to a method and a device for actuating at least one wheel brake device of a vehicle for preventing inadvertent rolling. A driving off assistance mode with a predefined brake pressure reduction is activated in the at least one wheel brake device if
the stationary state of the vehicle has been detected (50) and
the vehicle is located (51) on an incline, when viewed in the longitudinal direction of the vehicle, and
an uphill direction was detected (52) as the designated driving off direction of the vehicle. The brake pressure reduction can take place with a delay after the brake pedal has been released in such a way that the vehicle rolls back at a crawling speed.

The invention relates to a method and a device for actuating at least one wheel brake device of a vehicle for preventing inadvertent rolling when driving off on an incline with an uphill direction of travel.

Such a method and such a device are known, for example, from DE 196 21 628 A1. In said document, the braking force is maintained at at least one wheel brake, to be precise independently of the degree of activation of the pedal. When the brake pedal is released, the brake pressure is automatically reduced so that the vehicle can roll. In order to improve the driving off process, the brake pressure can be maintained in the at least one wheel brake by means of the status of the clutch pedal until the driver releases the brake and drives off.

The object of the present invention is to provide a method of the type mentioned at the beginning and a device for carrying out this method with improved.

This object is achieved according to the features of patent claim 1 and of patent claim 11, respectively.

The driving off assistance mode is activated automatically if either the vehicle is stationary on an incline and an uphill direction was detected as the designated driving off direction of the vehicle desired by the driver or if the vehicle begins to roll starting from the stationary state, in the opposite direction to the designated driving off direction.

In the driving off assistance mode, the brake pressure varies in accordance with a predefined profile and/or as a function of predefinable conditions, with the driver thus being provided with assistance when driving off on an incline. At the same time, there is a possibility of permitting the vehicle to roll back on the incline when desired by the driver so that maneuverings and/or parking is made easier on the incline.

If the driving off assistance mode is active, the brake pressure in the at least one wheel brake device is not reduced in accordance with the brake pedal position but rather according to a predefined sequence.

Advantageous refinements of the method according to the invention or of the device according to the invention emerge from the dependent patent claims.

It is advantageous if the maintaining brake pressure which is predefined by the brake pedal position at the time when the driving off assistance mode is switched on is maintained for a predefined delay period after the complete release of the brake pedal for as long as a driving off request of the driver has not been detected. Within the delay period the driver still has sufficient time to change over his foot from the brake pedal to the accelerator pedal and initiate the driving off process without the vehicle being able to roll back in the opposite direction to the desired driving off direction.

During the transition phase between idling and completely held load torque (for example when the friction clutch in change speed gearboxes is completely closed), the engine speed and engine torque have a characteristic profile from which a driving off request can be detected. The values of the current engine speed and of the current engine torque are available on the vehicle bus (for example CAN bus) in contemporary vehicles so that the driving off process can easily be detected without an additional sensor system.

The driving off request can be detected here by virtue of the fact that the derivative of the engine torque over time is greater than or equal to a predefinable threshold value for the change in the engine torque and at the same time the derivative of the engine speed over time is less than or equal to a predefinable negative threshold value for the change in the engine speed. The driving off request is particularly reliably detected as a result of this and inadvertent rolling back owing to an excessively low engine torque is prevented even on severe inclines.

The values of the engine torque (M) and/or of the engine speed (N) are expediently prefiltered before the derivative over time, in particular by means of the polynomial moving average method, as a result of which large errors in the values of the respective derivative over time can be avoided.

Furthermore, it is advantageous if, after the expiry of the delay period, the maintaining brake pressure is automatically reduced to a crawling brake pressure. This crawling brake pressure may be open-loop or closed-loop controlled here in such a way that the vehicle rolls downhill with a predefinable crawling speed. As an alternative to this it is also possible to set the crawling brake pressure lower than the maintaining brake pressure by an amount equal to a predefinable pressure difference, in which case the pressure difference can be determined as a function of the current incline of the road.

The crawling brake pressure can also be applied automatically by open-loop or closed-loop control if the vehicle begins to roll out of the stationary state in the opposite direction to the designated driving off direction.

The designated driving off direction can easily be determined by reference to the gearspeed selected by the driver. Together with the value of an inclination sensor for determining the incline it is then possible to detect whether or not the driver wishes to drive off in an uphill direction.

The method and the device according to the invention are explained in more detail below with reference to the appended drawing, in which:

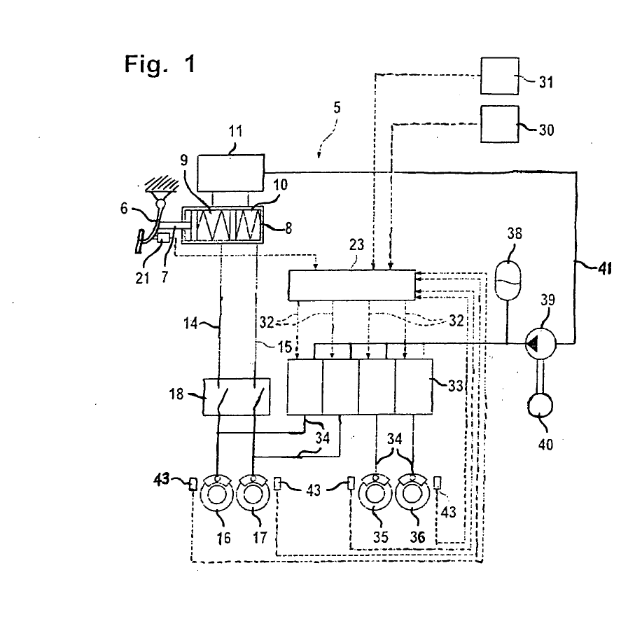

FIG. 1 shows an exemplary embodiment of a device according to the invention in a schematic illustration,

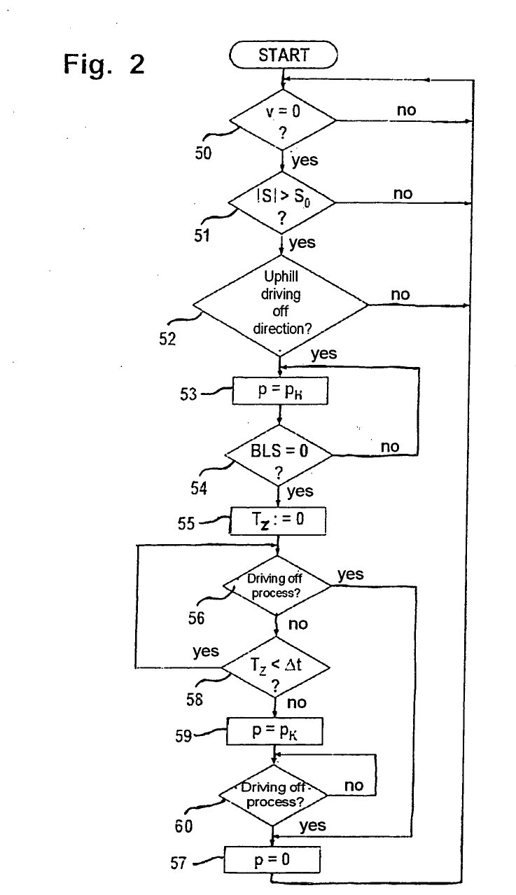

FIG. 2 is a flowchart of an exemplary embodiment of the method according to the invention, and

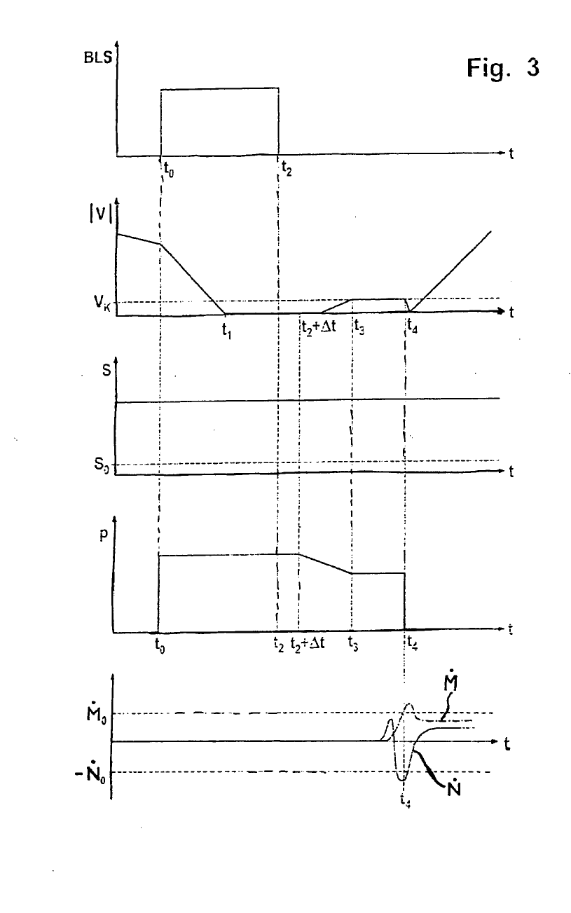

FIG. 3 shows an exemplary profile of the brake light signal, of the speed of the vehicle, of the incline of the road, of the brake pressure in a wheel brake device, and the derivative of the engine torque and of the engine speed over time as a function of time.

FIG. 1 shows a brake device 5 which is embodied as an electrohydraulic brake device. A brake pedal 6 is connected in a manner known per se to a tandem master brake cylinder 8 via a brake pedal linkage 7. The tandem master brake cylinder 8 has two working chambers 9, 10 which are separated fluidically and to each of which brake fluid is fed from a reservoir vessel 11.

The two working chambers 9, 10 can be connected fluidically directly to the two wheel brake devices 16, 17 of the front axle via one emergency brake line 14, 15 each. This fluidic connection is formed if a valve arrangement 18 which is inserted into the emergency brake lines 14, 15 is switched over into its emergency switching position and opens the respective fluidic connections. The valve arrangement 18 is then switched over into its emergency switching position if a defect occurs in the electric open-loop or closed-loop control of the electrohydraulic brake device 5.

A brake light switch 21 is provided in a manner known per se and generates a brake light signal BLS which, when the brake pedal is activated, assumes the value one (“HIGH”) and otherwise has the value zero (“LOW”) when the brake pedal is not activated. The brake light signal BLS is transmitted to a control device 23.

As an alternative to the brake light switch 21 it is possible for the brake light signal BLS also to be generated by signals from other vehicle devices. For example by means of pedal travel sensor signals and/or master brake cylinder brake-pressure signals, that is to say all signals from which activation of a brake pedal can be determined.

It is to be noted at this point that for sake of better differentiation the electrical lines in FIG. 1 are represented by dashed lines while the fluidic lines are represented by unbroken lines.

In the preferred embodiment according to FIG. 1, an inclination sensor 30 is also provided, said inclination sensor 30 measuring the inclination of the underlying surface in the longitudinal direction of the vehicle and transmitting it to the control device 23 by means of an electric signal line. Furthermore, an engine controller 31 transmits, to the control device 23, the values of the current engine speed N and the current engine torque M which is determined in the engine controller 31 by means of an estimation method which is known per se.

The control device 23 controls a brake-pressure modulation unit 33 via four control lines 32. The brake-pressure modulation unit 33 is connected fluidically to the wheel brake devices 16, 17, 35, 36 via one brake line 34 each so that the brake pressure in each wheel brake device 16, 17, 35, 36 can be set on a wheel-specific basis. On the input side, the brake-pressure modulation unit 33 is supplied with highly pressurized brake fluid from a high-pressure accumulator 38. The high-pressure accumulator 38 and the input side of the brake-pressure modulation unit 33 are connected to the output side of a pump 39 which is driven by an electric motor 40 and supplies the high-pressure accumulator 38 and the brake-pressure modulation unit 33 with pressurized brake fluid. The suction side of the pump 39 is fluidically connected to the reservoir vessel 11 via a supply line 41.

The brake device 5 has an automatic stationary state detection means. For this purpose, the wheel brake signals of at least one wheel, which are measured by a wheel speed sensor 43, are fed to the controller 23 via an electric line. In the preferred exemplary embodiment according to FIG. 1, the wheel speed signals of all the wheels are measured by means of one wheel speed sensor 43 each and passed on to the control device 23. The stationary state of the vehicle can be detected in a manner known per se from the wheel speed signals, this being a precondition for the activation of the driving off assistance mode.

The method sequence is explained in detail with reference to FIGS. 2 and 3.

FIG. 2 shows a flowchart of a preferred embodiment of the method according to the invention. After the start, there is firstly an interrogation in step 50 to determine whether the vehicle is in the stationary state, when the vehicle speed v is equal to zero. If this is not the case, this interrogation is repeated cyclically.

If the vehicle stationary state has been detected in step 50, in the subsequent step 51 it is tested whether the vehicle is on an incline. To do this, the incline value s of the inclination sensor 30 is compared in terms of absolute value with an incline threshold value s₀. If the absolute value of the current incline exceeds the threshold value s₀ of the incline, it is concluded therefrom that the vehicle is on an incline. The threshold value so of the incline can basically be predefined as desired and in the exemplary embodiment it is only slightly larger than zero. Alternatively a value equal to zero can also be selected.

If an incline (s≧s₀) has been detected, the method is continued with step 52. Otherwise, the system jumps back to step 50.

In step 52 it is checked whether an uphill direction or a downhill direction has been selected as the designated driving off direction desired by the driver. The driving off direction which is designated by the driver is determined, for example, from the gearspeed selected by the driver, which can be sensed, for example, by means of a sensor (not illustrated in more detail). From the incline value of the inclination sensor 30 it is then possible to determine whether the designated driving off direction corresponds to driving off in an uphill or downhill direction. If the idling mode or the neutral position is selected, an uphill driving off direction is assumed, and when the other necessary n conditions are fulfilled the driving off assistance mode is activated.

If the desired driving off direction corresponds to driving off in an uphill direction, in step 53 the current brake pressure p is held in the wheel brake devices 16, 17 35, 36 and thus maintained. This may be done, for example, using the inlet and outlet valves of an ABS system, which are not illustrated here. The brake pressure p which has now been set will be referred to as maintaining brake pressure p_{H}.

Alternatively, if the driving off direction does not correspond to an uphill direction, the system jumps back to step 50.

After step 53 an interrogation is carried out to determine whether the brake light signal BLS has the value zero (step 54). If this is not the case, the steps 53 and 54 are repeated and the maintaining brake pressure p_{H} in the wheel brake devices 16, 17, 35, 36 remains unchanged.

As soon as the driver completely releases the brake pedal into its position of rest (BLS=0), the maintaining brake pressure pH is still maintained for a predefinable delay period Δt and then reduced. To do this, a timing counter T_{z} is firstly set to zero in step 55, and then there is an interrogation to determine whether a driving off process is occurring (step 56).

During the transition phase between idling and completely held load torque (for example when the friction clutch in change speed gearboxes is completely closed), the engine speed and engine torque have a characteristic profile from which a driving off process can be detected. When driving off with a vehicle with a friction clutch and change speed gearbox, the driver firstly opens the throttle so that the engine speed N rises. Directly after this, the driver starts to close the clutch in order to slowly match the engine speed N and the driving shaft speed to one another. In the process, the engine speed N drops and the engine torque M rises. A driving off process is concluded if the derivative \dot{M} of the engine torque M of the vehicle over time is greater than or equal to a predefined positive threshold value \dot{M}₀ for the change in the engine torque and at the same the derivative \dot{N} of the engine speed N over time is equal to or smaller than a predefined negative threshold value −\dot{N}₀ for the change in the engine speed. If this is the case, the brake pressure p in the wheel brake devices 16, 17, 35, 36 is reduced to zero (step 57).

In the interrogation in step 57, a driving off process is detected, for example, only if the interrogated conditions (\dot{M}≧\dot{M}₀ and \dot{N}≦−\dot{N}₀) mentioned above are fulfilled continuously during a predefined time period or during a predefined number of interrogation cycles. As a result, faulty driving off process detections can be further avoided.

Furthermore, in a modification of the illustrated preferred exemplary embodiment, it is possible, when interrogating the driving off process, to take into account additional variables such as the engine speed, the engine torque or the accelerator pedal position.

The derivatives \dot{M} and \dot{N} of the engine torque M and of the engine speed N over time are calculated in the control device 23. To do this, firstly both the value of the engine torque M and the value of the engine speed N are filtered in order to reduce errors in the time derivatives. The filtering is carried out, for example, by means of the “moving average method” which is known per se, with a weighted average value formation being carried out by means of the respective four to seven last values. As a result, a type of low-pass filtering is carried out and fluctuations are compensated. Only after this are the time derivatives calculated in the control device 23 by means of numerical differentiation.

If a driving off process was not detected in step 56, in the next step 58 it is checked whether the delay period has already expired. To do this, the timing counter T_{z} is compared with the predefined value of the delay period Δt. If the timing counter T_{z} is less than the delay period Δt, the system jumps back to the preceding step 56. Otherwise, the delay period Δt since the brake pedal was released has expired and the maintaining brake pressure p_{H} is reduced in such a way that the vehicle rolls back in the opposite direction to the designated driving off direction. In the process, the speed of the vehicle is limited to a crawling speed v_{K}.

For this purpose, a crawling brake pressure p_{K} is set in step 59. This crawling brake pressure p_{K} can either be open-loop or closed-loop controlled in such a way that the vehicle rolls downhill precisely at the desired crawling speed v_{K}. It is alternatively also possible to apply, by open-loop or closed-loop control, a lower crawling brake pressure, which is reduced by a predefined pressure difference Δp, as the maintaining brake pressure p_{H}. The brake difference Δp can either be permanently predefined or determined as a function of the steepness of the incline. For example, it is possible to select lower values for the pressure difference Δp in direct proportion to the absolute value of the incline value s.

The controlled rolling back of the vehicle in the driving off assistance mode permits the driver to park and maneuver comfortably on an incline.

In a modification of the illustrated exemplary embodiment it is also possible to set the crawling brake pressure p_{K} when the vehicle begins to roll starting from the detected stationary state in the opposite direction to the designated driving off direction. The rolling and the rolling direction can be determined by means of the wheel speed sensors 43. With contemporary wheel speed sensors 43 it is already possible to detect the direction of rotation after a few signal edge profiles of the wheel speed signal. In this alternative of the method according to the invention it is thus possible to dispense with the inclination sensor in the vehicle.

After the crawling brake pressure p_{K} has been set, in step 60 checking is carried out, analogously to step 56, to determine whether a driving off request of the driver is present, and if this is the case the braking pressure p in the wheel brake devices 16, 17, 35, 36 is completely reduced (step 57). Otherwise the interrogation is repeated cyclically in this step 60.

FIG. 3 shows five individual diagrams, with the abscissa representing the time axis in each case. In the top diagram, the brake light signal BLS is plotted. Illustrated below this are the vehicle speed v, the incline value s in the longitudinal direction of the vehicle, the brake pressure p in the wheel brake devices 16, 17, 35, 36 and the derivative \dot{M} of the engine torque M over time and the derivative \dot{N} of the engine speed N over time.

At the time t₀, the driver activates the brake pedal 6 and sets a specific brake pressure p, which corresponds, for example, to the maintaining brake pressure p_{H}. The brake light signal BLS has a rising signal edge at the time t₀. The speed v of the vehicle reduces starting from the time t₀, and at the time t₁ the vehicle speed v is approximately zero so that the vehicle is in the stationary state.

At this time t₁, the vehicle is located on an incline with an incline value s which is larger in absolute terms than the incline threshold value S₀. It is assumed that the driving off direction which is determined by means of the selected gearspeed is in the uphill direction so that the driving off assistance mode is activated at the time t₁.

In FIG. 3 it is to be noted that the driver completely releases the brake pedal 6 into its position of rest starting from the time t₂ so that the brake light signal BLS has a falling signal edge and assumes the value zero. During the delay period Δt, the maintaining brake pressure p_{H} in the wheel brake devices 16, 17, 35, 36 remains unchanged. This would allow the driver sufficient time to set a driving off process with sufficient engine torque M and drive off without rolling back.

However, in the example illustrated in FIG. 3 the driver wishes to allow the vehicle to roll back downhill. After the delay period Δt has expired at the time t₂+Δt, the brake pressure p is reduced to the crawling brake pressure p_{K} in accordance with a brake pressure gradient which can be predefined as desired, with the result that the vehicle moves downhill at the crawling speed v_{K} in the opposite direction to the designated driving off direction. At the time t₃, the brake pressure p corresponds to the crawling brake pressure p_{K} and the speed v of the vehicle has assumed the crawling speed v_{K}.

At the time t₄, a driving off process is detected: the derivative \dot{M} of the engine torque M over time reaches or exceeds the positive threshold value \dot{M}₀ for the change in the engine torque, with the derivative \dot{N} of the engine speed N over time being lower at this time than the negative threshold value −\dot{N}₀ for the change in the engine speed. The brake pressure p is reduced and the speed v of the vehicle in the uphill direction of travel increases.

1-12. (canceled)

13. A method for actuating at least one wheel brake device of a vehicle for preventing inadvertent rolling when a vehicle is stationary, wherein a driving off assistance mode with a predefined brake pressure profile is activated in the at least one wheel brake device if
the stationary state of the vehicle has been detected and the vehicle is located on an incline, when viewed in the longitudinal direction of the vehicle, and an uphill direction was detected as the designated driving off direction of the vehicle, or
the vehicle begins to roll starting from the detected stationary state, in the opposite direction to the designated driving off direction, characterized in that the maintaining brake pressure (p_{H}) which is predefined at the time when the driving off assistance mode which is predefined by the brake pedal position is switched on is maintained for a predefined delay period (Δt) after the complete release of the brake pedal for as long as a driving off request of the driver has not been detected, wherein the driving off request of the driver is detected by virtue of the fact that the derivative (\dot{M}) of the engine torque (M) over time is greater than or equal to a predefinable threshold value (\dot{M}₀) for the change in the engine torque and simultaneously the derivative (\dot{N}) of the engine speed (N) over time is less than or equal to a predefinable negative threshold value (−\dot{N}₀) for the change in the engine speed.

14. The method as claimed in claim 13, characterized in that the values of the engine torque (M) and/or of the engine speed (N) are prefiltered before the derivation over time, in particular by means of the polynomial moving average method.

15. The method as claimed in claim 13, characterized in that when the start of rolling of the vehicle in the opposite direction to the designated driving off direction is detected a crawling brake pressure (p_{K}) is automatically set.

16. The method as claimed in claim 13, characterized in that, after the expiry of the delay period (Δt), the maintaining brake pressure (p_{H}) is automatically reduced to a crawling brake pressure (p_{K}).

17. The method as claimed in claim 16, characterized in that the crawling brake pressure (p_{K}) is set lower than the maintaining brake pressure (p_{H}) by an amount equal to a predefinable pressure difference (Δp).

18. The method as claimed in claim 16, characterized in that the crawling brake pressure (p_{K}) is set in such a way that the vehicle rolls downhill with a predefinable crawling speed (v_{K}).

19. The method as claimed in claim 13, characterized in that the designated driving off direction is determined by reference to the gear speed selected by the driver.

20. A device for carrying out the method as claimed in claim 13, having a control device (23) for controlling the brake pressure (p) in at least one wheel brake device (16, 17, 35, 36) of a vehicle, wherein
means (43) for determining the vehicle speed,
means (30) for determining the incline of the road in the longitudinal direction of the vehicle, and
means for determining the designated driving off direction of the vehicle,
are provided, wherein a driving off assistance mode with a predefined brake pressure profile is activated in the at least one wheel brake device (16, 17, 35, 36) by means of the control device (23) if
the stationary state of the vehicle has been detected and
the vehicle is located on an incline, when viewed in the longitudinal direction of the vehicle, and
an uphill direction was detected as the designated driving off direction of the vehicle, characterized in that the maintaining brake pressure (p_{H}) which is predefined at the time when the driving off assistance mode which is predefined by the brake pedal position is switched on is maintained for a predefined delay period (Δt) after the complete release of the brake pedal for as long as a driving off request of the driver has not been detected, wherein the driving off request of the driver is detected by virtue of the fact that the derivative (\dot{M}) of the engine torque (M) over time is greater than or equal to a predefinable threshold value (\dot{M}₀) for the change in the engine torque and simultaneously the derivative (\dot{N}) of the engine speed (N) over time is less than or equal to a predefinable negative threshold value (−\dot{N}₀) for the change in the engine speed.

21. The device as claimed in claim 20, characterized in that means for determining the gear speed selected by the driver are present in order to determine the designated driving off direction.
